(19) United States
(12) Patent Application Publication
(10) Pub. No.: US 2014/0051436 A1
(43) Pub. Date: Feb. 20, 2014

(54) METHODS AND DEVICES FOR IDENTIFYING LOCAL AREA NETWORKS

(71) Applicants: Haijin Yan, Hainesville, IL (US); Craig J. Detter, Gurnee, IL (US); Ryan D. Speer, Libertyville, IL (US); William F. Taranowski, Libertyville, IL (US)

(72) Inventors: Haijin Yan, Hainesville, IL (US); Craig J. Detter, Gurnee, IL (US); Ryan D. Speer, Libertyville, IL (US); William F. Taranowski, Libertyville, IL (US)

(73) Assignee: MOTOROLA MOBILITY LLC, Libertyville, IL (US)

(21) Appl. No.: 13/586,181

(22) Filed: Aug. 15, 2012

(51) Int. Cl. H04W 76/00

(52) U.S. Cl. 455/434

(57) ABSTRACT

A method (500) for identifying a local area network (103) with a mobile device (100) includes scanning (504) for available local area networks with a wireless communication circuit. Upon detecting an available local area network, a base station (502) of the local area network pushes a MAC address (122) to the mobile device. The mobile device then determines (512) one or more of a host identifier, network purveyor, network location, other information, or combinations thereof, from the MAC address without having to resolve geographic coordinates.

### BACKGROUND

1. Technical Field

This invention relates generally to electronic devices, and more particularly to network detection in electronic devices.

2. Background Art

Portable electronic devices are continually becoming more advanced. For example, while mobile telephones were once used only for telephone calls, today “smart phones” allow users to capture photographs, send and receive text and multimedia messages, and surf the web. These increasing functions sometimes depend, however, upon available networks and device capabilities. Further, some of the advanced functions tend to consume large amounts of energy from energy storage devices and processing power.

It would be advantageous to have a mobile device that offered advanced network detection features while reducing the amount of energy and processing power required to accomplish the same.

### BRIEF DESCRIPTION OF THE DRAWINGS

FIG. 1 illustrates one explanatory portable electronic device in an operational environment, along with a schematic block diagram and a network schematic, configured in accordance with one or more embodiments of the invention.

FIG. 2 illustrates one explanatory portable electronic device being used to determine a host identifier or provider of a network in accordance with one or more embodiments of the invention.

FIG. 3 illustrates one explanatory portable electronic device being used to determine a host identifier or provider of a network in accordance with one or more embodiments of the invention.

FIG. 4 illustrates a display of one explanatory device upon determining a host identifier or provider of a network in accordance with one or more embodiments of the invention.

FIG. 5 illustrates a method of determining a host identifier or provider of a network in accordance with one or more embodiments of the invention.

FIG. 6 illustrates a method of determining a host identifier or provider of a network in accordance with one or more embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF EMBODIMENTS OF THE INVENTION

Before describing in detail embodiments that are in accordance with the present invention, it should be observed that the embodiments reside primarily in combinations of method steps and apparatus components related to identifying networks, host identifiers of networks, purveyors of networks, and delivery of content as described herein. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of network, host identifier, purveyor, or location detection as described herein. The non-processor circuits may include, but are not limited to, a radio receiver, a radio transmitter, signal drivers, clock circuits, power source circuits, and user input devices. As such, these functions may be interpreted as steps of a method to perform network, host identifier, purveyor, or location detection, as well as the corresponding delivery of content. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide devices and methods use to determine the identity of networks, and device location, without using any geographic coordinates. More specifically, by using only a multiple access control (MAC) address, devices configured in accordance with embodiments of the invention can determine which businesses or third parties are nearby, who is operating nearby local area networks, and even the location of the device, without the use of latitude or longitude coordinates.

In one embodiment, a mobile device is configured to scan for available local area networks with a wireless communication circuit. Once available local area networks are detected, a base station of the local area network pushes, in one embodiment, only its MAC address to the mobile device. The mobile device then uses the received MAC address, either by referencing the MAC address with a locally cached look-up table or by transmitting the MAC address to a third party service provider, to determine a host identifier or purveyor of the network. Where a look-up table is cached within the mobile device, in one or more embodiments the look-up table can be provisioned via over-the-air data delivery. Further, the look-up table can be updated wirelessly in accordance with a provider's updating methods. Moreover, in one or more embodiments, the look-up table can include not only host identifiers and/or purveyors corresponding to MAC addresses, but information relating to those host identifiers and/or purveyors. This additional information can be based upon a user's past acceptance records, past search records, preferences configured within the mobile device, personal interests, or other criteria. The inclusion of this information, which in one embodiment limits the number of listed host identifiers and/or purveyors in accordance with the past acceptance records, past search records, preferences configured within the mobile device, personal interests, or other criteria, helps to streamline and improve the identification procedure and user experience. Regardless of method, once the host identifier or purveyor is identified from the MAC address, the mobile device can optionally allow content from the network to be pushed. This can all be done, in one embodiment, without the use of latitudinal or longitudinal coordinates, which are required by prior art solutions.

For example, if the available network is a local area network provided by a restaurant called “Joe's Burgers,” upon a user's device detecting the network, a base station at Joe's Burgers would then push its MAC address to the mobile device. Upon receiving the MAC address, in one embodiment the mobile device can reference a locally cached look-up table that has host identifiers, purveyors, locations, or combinations thereof, correlated with a listing of MAC addresses. In an alternate embodiment, the mobile device transmits the received MAC address to a third party service provider with whom Joe's Burgers has contracted for MAC address identification. In the latter embodiment, the third party service provider responds with a host identifier, network purveyor, location, or combination thereof. Upon identifying the network at Joe's Burgers in this fashion, the mobile device can optionally register with the base station at Joe's Burgers. Where this occurs, the base station can push content to the mobile device. Examples of content include coupons, special offers, promotions, advertisements, and so forth.

Embodiments of the invention offer many advantages over prior art systems. In prior art systems, location based services generally require geographic coordinates, e.g., a latitudinal coordinate and a longitudinal coordinate to determine location. However, there are problems associated with the use of these geographic coordinates. For example, to determine a particular location, a mobile device must actuate its global positioning system hardware. This hardware consumes a great deal of power, and thus can substantially shorten the amount of energy available for other operations. Moreover, when the mobile device is indoors, global positioning system signal strength may be too weak to be useful in determining the location.

Embodiments of the present invention allow for location and other information to be determined without latitude or longitude information, and further without requiring the use of global positioning system hardware. Embodiments of the present invention provide a platform for location based, push service that uses the MAC address of a base station in an available local area network, such as a Wi-Fi network, as mechanism to determine location, host identifier, network purveyor, or other information. As a mobile device configured in accordance with embodiments of the invention scans for available local area networks, employment of a MAC address as an identifier allows the mobile device to determine location, host identifier, purveyor, or other information via simply matching a MAC address with identifying information. This reduces overall power consumption.

In one embodiment, network purveyors are able to register their locational information and MAC addresses with a third party service provider. The network purveyors are then able to update information associated with their local area networks on a real time basis. When a user of a mobile device also subscribes to the service, receipt of a network purveyor's MAC address is instantly forwarded by the user's mobile device to the third party service provider. A match results in host identifier, purveyor, location, or other information being sent back to the mobile device from the third party service provider. This information indicates that the user's mobile device has detected a particular location, and further that the mobile device is within range of the purveyor's network. Accordingly, the network purveyor can push information—such as promotional offers—corresponding to the purveyor to the mobile device in real time. Systems described herein can be used for advertisement serving within a local area network, social coordination and convention support, and other general location based information delivery.

Systems described herein can be used as a location based informational push service for mobile devices. In one embodiment, a system configured in accordance with embodiments of the invention includes four main components: a platform, a publisher, a subscriber, and a mobile agent. The platform includes a data center with servers that provide open access to the various parties, publishers, subscribers, and mobile agent. The publishers can be business providers or advertisement providers. Publishers register locations and the data that needed to be pushed on the platform, and further correlate these locations and data to specific MAC addresses of base stations disposed within subscribers' networks. The subscribers are either network providers or users who subscribe to the service, in one embodiment, as described above. The mobile agent is an application or mobile service operating on one or more processors of a mobile device that receive push events. Subscribers can configure the mobile agent with filters to limit the amount of pushed data. Subscribers can further configure the mobile agent with other policies regarding which available networks should respond to the platform.

In practice, a network provider, such as a shopping mall offering Wi-Fi networks throughout the mall, would constitute one type of publisher. The shopping mall registers—with the platform—MAC addresses of base stations operating within its network. The shopping mall further registers location indicators, host identifiers, purveyor information, or other information with the platform. The platform then correlates this information with one or more specific MAC addresses. The publisher can—at anytime—add or update information associated with each MAC address. This information will be pushed to subscribers upon receipt of a predetermined MAC address.

A user, who is a subscriber, has a mobile device, which may be a smart phone, tablet, portable computer, personal digital assistant, media player, or other device. The user configures a mobile agent within the device with information of interest to the user. When the user passes through the mall with her mobile device, the mobile agent, on the mobile device, scans for available local area networks using a wireless communication circuit. Upon detecting an available local area network, the base station serving the mobile device pushes its MAC address to the mobile device. The mobile device forwards the MAC address to the platform. The platform responds with the information that has been provided by the publisher and that is correlated with the MAC address. The mobile device can then register with the base station, if desired. The base station can then push additional information to the mobile device.

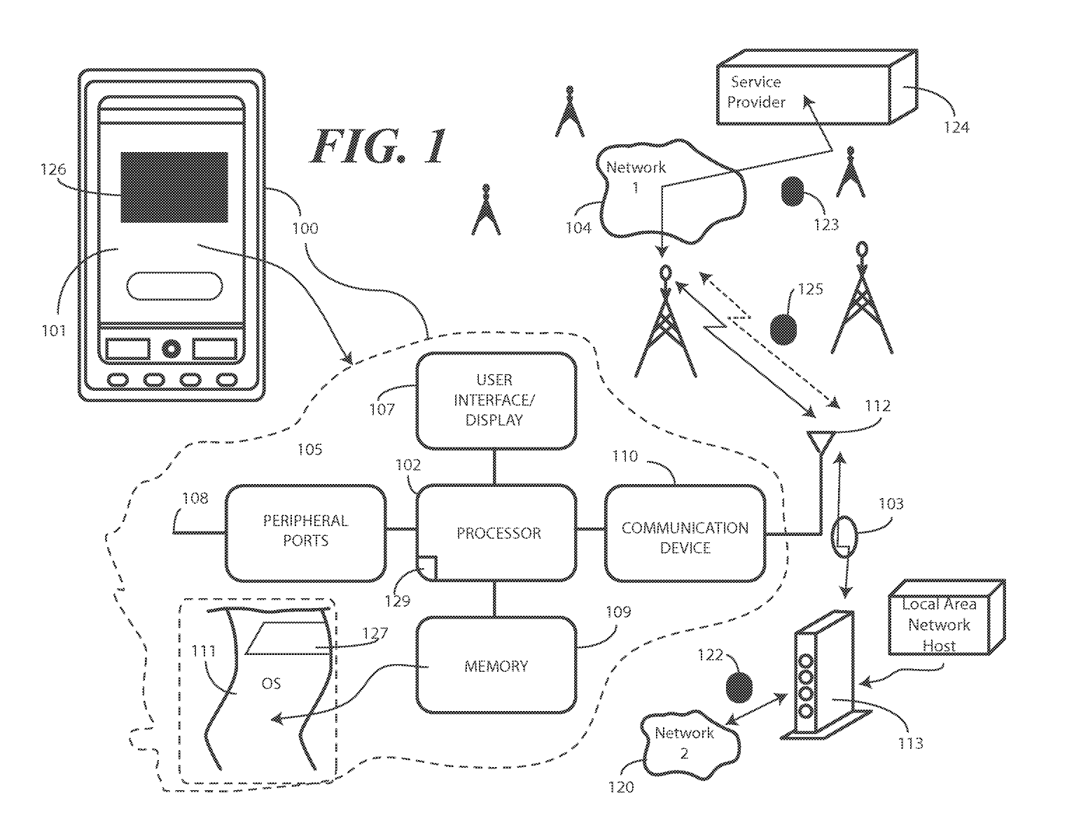

Turning now to FIG. 1, illustrated therein is one embodiment of a mobile device 100 configured in accordance with one or more embodiments of the invention. The illustrative mobile device 100 of FIG. 1 is shown as a smart phone for illustration. However, it will be obvious to those of ordinary skill in the art having the benefit of this disclosure that other portable electronic devices may be substituted for the explanatory smart phone of FIG. 1. For example, the mobile device 100 may be configured as a palm-top computer, a tablet computer, an Ultra-book computer, a gaming device, a media player, or other device.

The illustrative mobile device 100 may include standard components such as a user interface 107 and associated modules. The user interface 107 can include various combinations of a display, a keypad, voice control modules, and/or touch sensitive interfaces. The mobile device 100 includes a communication device 110. The communication device 110 is configured for communication with one or more networks 104,103,120, and can include wireless communication circuitry, one of a receiver, a transmitter, or transceiver, and an antenna 112.

The communication device 110 is configured for data communication with at least one wide area network 104. For illustration, the wide area network 104 of FIG. 1 is shown as a cellular network being operated by a service provider. Examples of cellular networks include GSM, CDMA, W-CDMA, CDMA-2000, iDEN, TDMA, LTE, and other networks. It should be understood that the communication device 110 could be configured to communicate with multiple wide area networks as well, with one being shown in FIG. 1 for simplicity.

The communication device 110 can also be configured to communicate with a local area network 103, such as a Wi-Fi network being supported by a base station, which is shown as local area network router 113 in FIG. 1. Local area networks can be connected through communication nodes, e.g., local area network router 113, to other networks, such as the Internet, which is represented by network 120 in FIG. 1. For example, the local area network 103 can provide data communication through a non-IMS channel.

The mobile device 100 includes a control circuit, which in FIG. 1 is illustrated as one or more processors 102. The control circuit is responsible for performing the various functions of the device. The one or more processors 102 can be a microprocessor, a group of processing components, one or more Application Specific Integrated Circuits (ASICs), programmable logic, or other type of processing device. The one or more processors 102 are operable with the user interface 107 and the communication device 110, as well as various peripheral ports 105 that can be coupled to peripheral hardware devices via interface connections 108.

The one or more processors 102 process and execute executable software code to perform the various functions of the mobile device 100. A storage device 109, such as a memory module, stores the executable software code used by the one or more processors 102 for device operation. The storage device 109 may also store identification information suitable for identifying the mobile device 100 or its user to the service provider 121. In one embodiment, the identification information includes information identifying the user and the type of subscription held by the user for wireless communication services. The one or more processors 102 are configured, in one embodiment, to host an operating system, shown illustratively as an operating system environment 111.

In accordance with embodiments of the invention, the communication device 110 is configured to search for available local area networks. Network 103 is one example of such a network. Upon detecting the available local area network, i.e., network 103, the base station in network 103 serving the mobile device 100, i.e., local area network router 113, pushes its MAC address 122 to the communication device 110 of the mobile device 100. Accordingly, the one or more processors 102 receive the MAC address 122 from network 103 via the communication device 110.

The one or more processors 102 of mobile device 100 can then identify network 103 by comparing the MAC address 122 to information correlated with the MAC address 122. This information can include a host identifier, a network purveyor, locational information, or other information. In one embodiment, the one or more processors 102 can locally cache a lookup table 123 received from a platform service provider 124. As noted above, when the lookup table 123 is locally cached, it can be periodically updated or contain information corresponding to a user's past acceptance records, past search records, preferences configured within the mobile device, personal interests, or other criteria in one or more embodiments. The lookup table 123, in one embodiment, lists one or more informational components by MAC address. By referencing the received MAC address 122 with the lookup table 123, the one or more processors 102 can determine which information corresponds to a particular address.

For example, in one embodiment the informational component comprises a host identifier. The host identifier, in one embodiment, comprises indicia identifying who or what entity is providing the available local area network, i.e., network 103. The host identifier can also comprise a physical address or other information. For instance, an example of a host identifier may be a simple provider name, e.g., “Mac's Dog Toy Bizarre.” Alternatively, another example of a host identifier may be “Welcome to Hartsfield International Airport in Atlanta.” Another example may be “This Network is Provided by Fred's Mall, located in the middle of of Blue's Old Stand, Ala.”

In another embodiment, the informational component can be a network purveyor. For example, the network purveyor information may be “Sun Restaurant of Fifth and Main.” In another embodiment, the network purveyor information may be “Frank's Coffee, less than 1000 feet away.” These are merely illustrations of explanatory host identifiers and network purveyors. Numerous others will be obvious to those of ordinary skill in the art having the benefit of this disclosure.

In one or more embodiments, the informational component can include promotional information or other advertising corresponding to the host or purveyor of the network 103. For example, in addition to identifying “Buster's Day Spa,” the informational component may include an offer of a free pair of sunglasses with a massage.

In another embodiment, upon receiving the MAC address 122, rather than referencing a locally cached lookup table 123, which can consume memory, the one or more processors 102 are configured to transmit the MAC address 122 received from the available local area network 103 to a remote server of the platform service provider 124. Upon receiving the MAC address 122, the platform service provider 124 provides an informational component 125 to the one or more processors 102 through the communication device 110. In one embodiment, the informational component 125 comprises indicia of the provider of the local area network 103, with that information being determined only from the MAC address 122. Upon receiving the informational component 125, the one or more processors 102 are able to determine the provider of the local area network 103. Since this information was based upon the MAC address 122, the one or more processors 102 have thus determined provider of the available local area network 103 from only the MAC address 122 by receiving the informational component 125 indicating the provider from the remote server of the platform service provider 124 in response to sending the same to the platform service provider 124. In one embodiment, the one or more processors 102 are then configured to present indicia 126 of the provider on the display 101 of the mobile device 100 in response to the determination of the provider.

In one embodiment, the informational component 125 includes locational information in addition to identifying the provider of the local area network 103. However, in one embodiment this locational information is devoid of geographic coordinates. Said differently, the locational information includes indicia suitable for the one or more processors 102 to determine a geographic location of the mobile device 100 without using latitude or longitude coordinates. One example of such indicia includes an address. A second example includes an approximation of distance to the base station of the network 103. A third example includes the name of a city, town, county, or other area. A fourth example includes the name of a nearby landmark or attraction, e.g., “Bob's Wig Emporium near the largest ball of twine on earth as certified by Guinness.” Other examples of locational information will be obvious to those of ordinary skill in the art having the benefit of this disclosure. By including locational information in the informational component 125, embodiments of the invention allow the one or more processors 102 to determine a geographic location of the mobile device 100 only from the MAC address 122, and without using geographic coordinates.

In one embodiment, the one or more processors 102 are configured to register the mobile device 100 with the available local area network 103 after the provider of the network 103 is determined In one embodiment, this includes transmitting an identifier 129 of the mobile device 100, such as a MAC address, telephone number, a serial number, and integrated circuit card identifier, an international mobile subscriber (IMS) identity, or other information, to the base station of the network 103 for registration with a local area network router 113 or other device. Once this occurs, the base station of the network 103 can push information to the mobile device 100, including promotional offers, advertisements, or other information.

In one or more embodiments, a user can configure the one or more processors 102 with user configurations 127 that limit or otherwise modify the amount of information that can be pushed to the mobile device 100. In one embodiment, the user configuration 127 includes a filter to select only certain purveyors. For example, a particular user may want to only receive offers from clothing stores. Accordingly, the user can configure the user configuration 127 such that informational components from network purveyors and hosts who sell clothing to be pushed to the mobile device 100. Accordingly, the one or more processors 102 would be configured to register the mobile device 100 with the available local area network 103 only where, for example, the identified provider is found in a predetermined list of providers stored in the user configuration 127 of the mobile device 100. While the user configuration 127 of FIG. 1 is illustratively stored in the operating system environment 111 of the mobile device 100, it could also be registered with the platform service provider 124. In that case, the platform service provider 124 would only forward informational component 125 where the provider corresponding to the MAC address 122 is found within the user's preferences as defined by the user configuration 127.

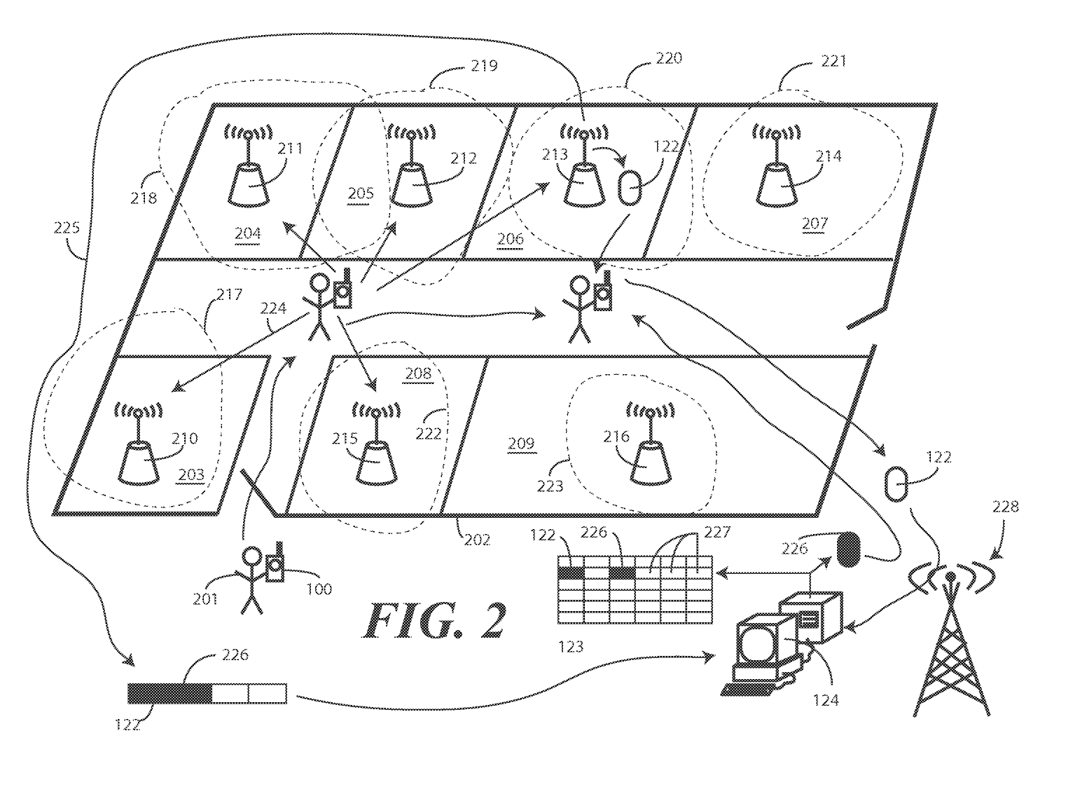

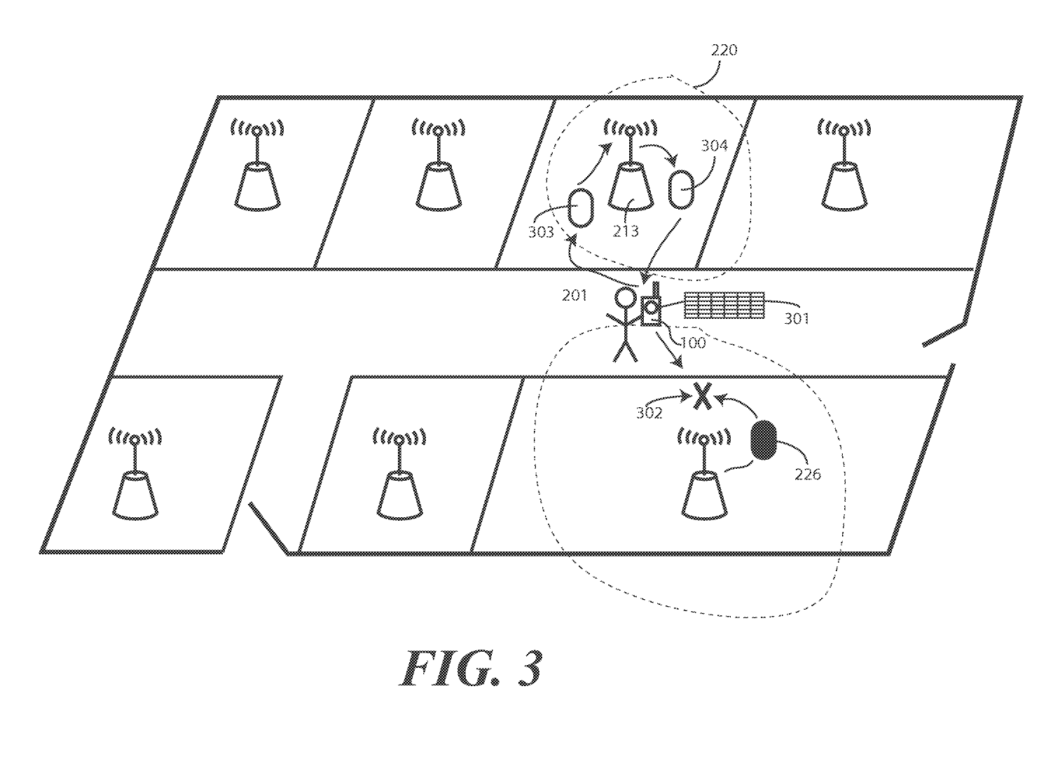

Turning now to FIGS. 2 and 3, illustrated therein is one explanatory use case that illustrates the methods and devices of embodiments of the present invention being used to determine network identification from a MAC address.

Beginning with FIG. 2, a user 201 having a mobile device 100 configured in accordance with one or more embodiments of the invention is shown entering a shopping mall 202. Within the shopping mall 202 are a number of shops 203,204,205,206,207,208,209. In this illustrative embodiment, each of these shops 203,204,205,206,207,208,209 includes a base station 210,211,212,213,214,215,216 that provides a corresponding local area network 217,218,219,220,221,222,223.

As the user 201 walks through the shopping mall 202, a wireless communication circuit of the mobile device 100 scans 224 for available local area networks. Presuming that there are no filters, locks, or other prohibitions, in this illustrative embodiment the wireless communication circuit would detect all available local area networks 217,218,219,220,221,222,223.

Upon detecting an available local area network, e.g., local area network 220, the base station 213 of that local area network 220 pushes its MAC address 122 to the mobile device 100. Accordingly, the wireless communication circuit of the mobile device 100 receives the MAC address 122 of the base station 213 in the local area network 220. From this received MAC address 122, the one or more processors of the mobile device 100 are able to determine a host identifier of the local area network 220. As noted above, in one or more embodiments, the host identifier is devoid of any geographic coordinates. In one embodiment the host identifier comprises an identity of the purveyor of the local area network 220. As described above, the host identifier can be geographic coordinate free, and yet can, nevertheless, include content information that identifies a location of the host of the local area network 220.

The identification by MAC address 122 is possible because the host of the local area network 220 has, in one embodiment, registered 225 the MAC address 122 and a corresponding host identifier 226 with a platform service provider 124. Accordingly, the platform service provider 124 has a table 123 of host identifiers 226 correlated with MAC addresses 122. Optionally, additional informational content 227 can be correlated with a given MAC address 122 as well. The mobile device 100 uses this table 123 to determine the host identifier 226 from, in one embodiment, only the received MAC address 122.

In one embodiment, platform service provider 124 delivers the table 123 to the mobile device 100 so that it can be cached in memory. In such an embodiment, the one or more processors of the mobile device determine the host identifier 226 by simply referencing the received MAC address 122 with the table 123.

In another embodiment, the one or more processors of the mobile device 100 determine the host identifier 226 by transmitting the MAC address 122 across a network 228 other than the local area network 220 to a remote server of the platform service provider 124. The remote server then references the MAC address 122 with the table 123 to determine the host identifier 226. The remote server then sends the host identifier 226 back to the mobile device 100, which receives the same.

Turning now to FIG. 3, if there is any filter in the mobile device 100, the one or more processors will access, in one embodiment, a predetermined list 301 of available networks upon receipt of the host identifier 226. If the host identifier 226 is not found in the predetermined list 301, the one or more processors of the mobile device 100 may be configured to preclude 302 the host identifier 226 from being received.

Where the host identifier 226 is otherwise acceptable, the mobile device 100 transmits from the wireless communication circuit a registration request 303 to the base station 213. Once registered with the base station 213, the base station 213 can push content 304 corresponding to a host of the local area network 220 to the mobile device 100. The mobile device 100 then receives the content 304 from the base station 213, and accordingly from the local area network 220. In one embodiment, such as when the host of the local area network 220 is a business, the content 304 comprises promotional offers from the business operation. In some embodiments, such as when the host identifier 226 is devoid of geographic coordinates, the content 304 may comprise information identifying the location of the host of the local area network 220, thereby allowing the user 201 to easily find out where to take advantage of any promotional offer found in the content 304.

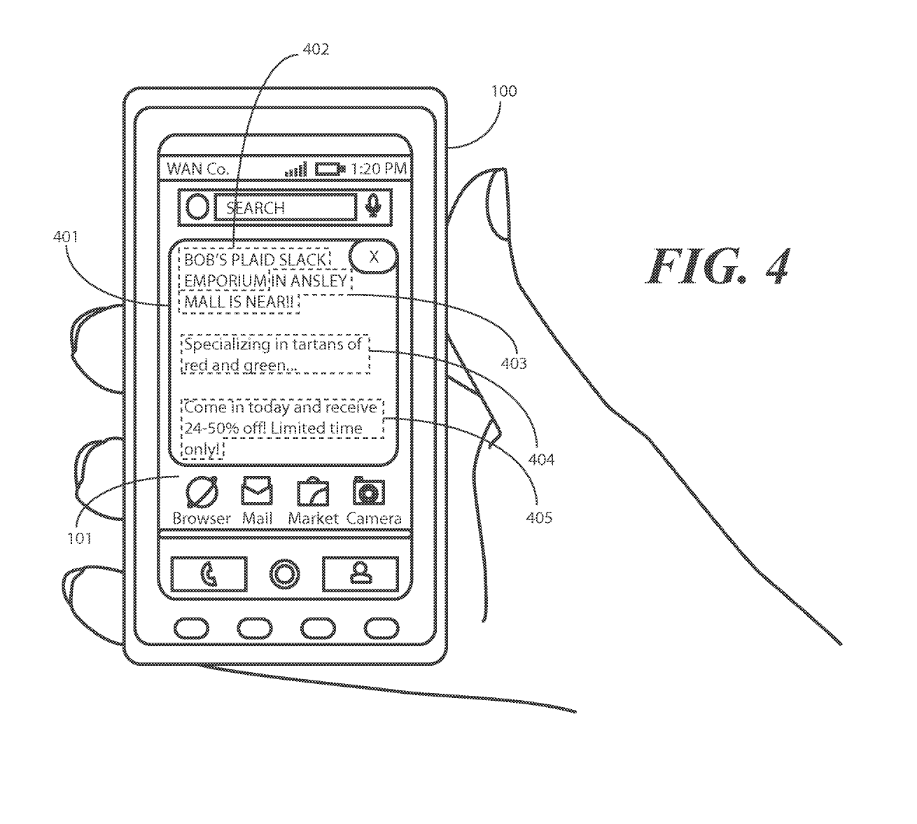

Turning now to FIG. 4, upon receipt of the content (304), in one embodiment the one or more processors of the mobile device 100 are configured to present indicia 401 of the provider of the local area network (220) on the display 101 of the mobile device. The illustrative indicia of FIG. 4 include purveyor information 402, locational information 403, content 404, and a promotional offer 405.

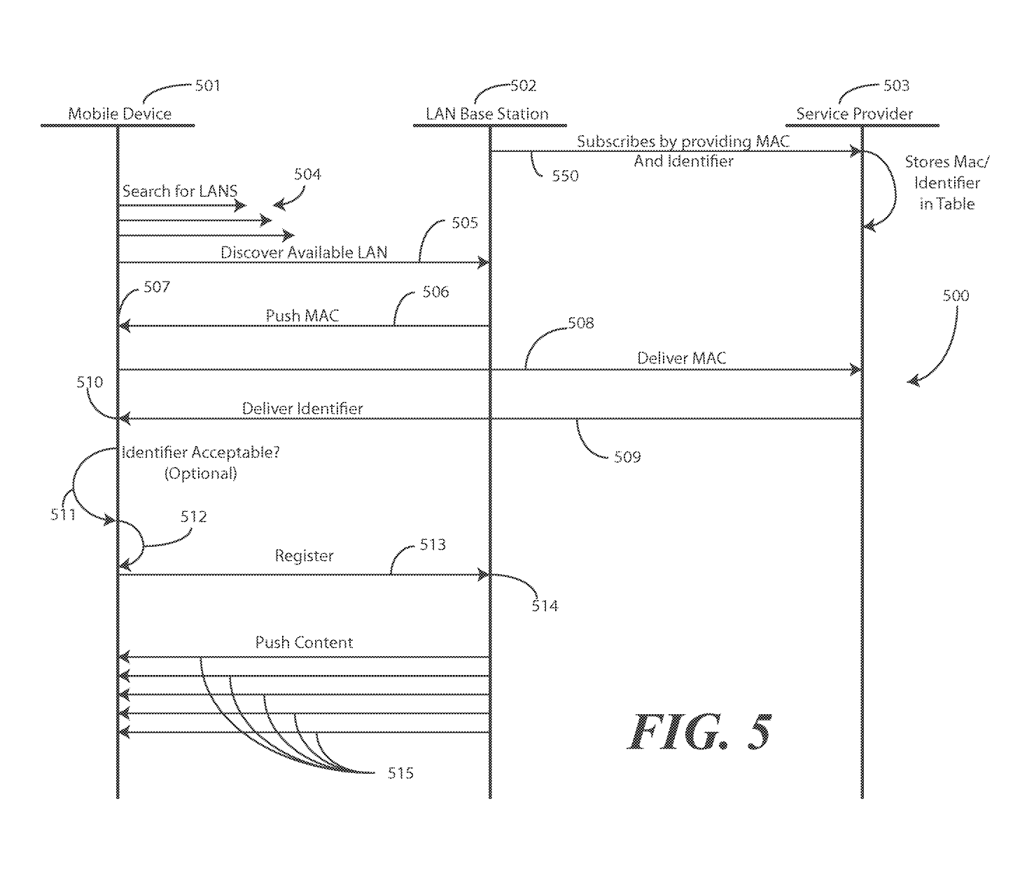

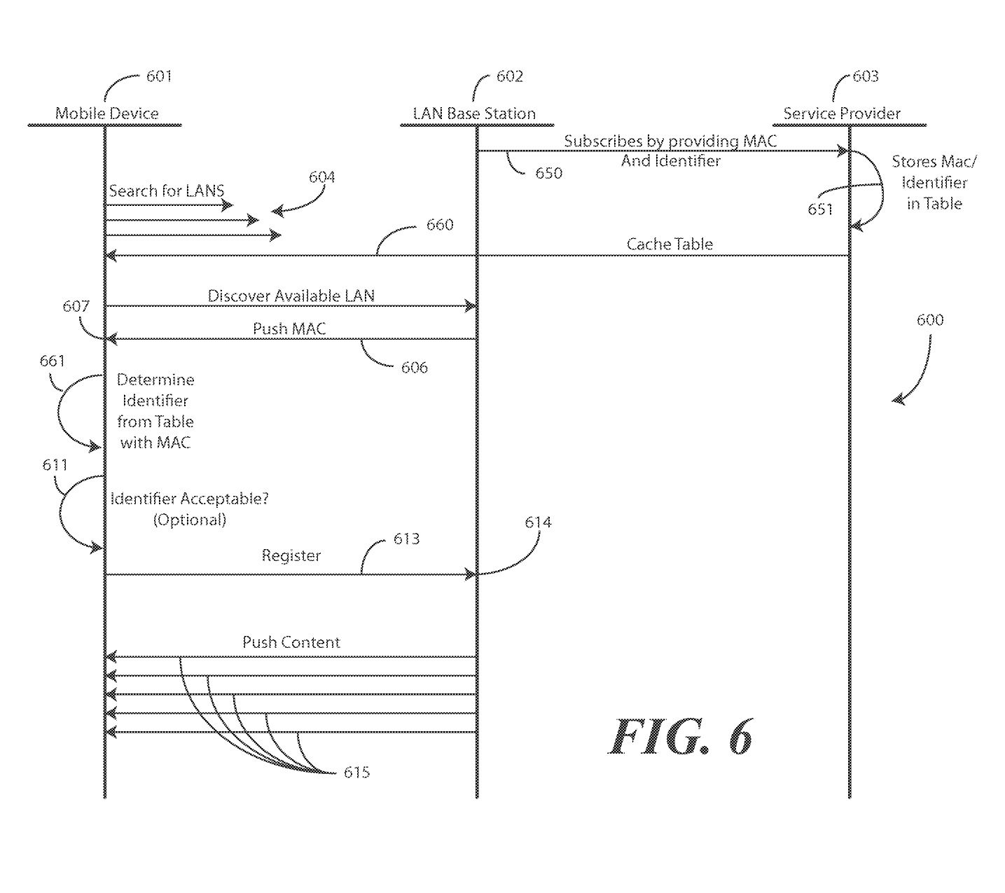

Turning now to FIGS. 5 and 6, illustrated therein are methods 500,600 for determining host identifiers, network purveyors, and other information using MAC addresses in accordance with embodiments of the invention. FIG. 5 illustrates a method 500 where the determination is made when a mobile device 501 forwards a received MAC address to a platform service provider 503. FIG. 6 illustrates a method 600 where the determination is made when the mobile device 601 references a lookup table in memory.

Turning first to FIG. 5, prior to interfacing with the mobile device 501, the provider of a local area network, via the base station 502 in one embodiment, subscribes 550 to a remote server of the platform service provider 503 by providing its MAC address and content corresponding to the MAC address to the platform service provider 503. The provider may also instruct the remote server of the platform service provider 503 to deliver the content to mobile devices upon receipt of the MAC address from those devices.

A mobile device 501 sometime later scans 504 for available local area networks with a wireless communication circuit of the mobile device 501. A base station 502 of an available local area network detects 505 the mobile device 501 being present within its local area network as a result of this scanning. In response to this detection, the base station 502 pushes 506 its MAC address to the mobile device 501. In one embodiment, the base station 502 pushes 506 only its MAC address to the mobile device 501. The mobile device 501 then receives 507 the MAC address of the base station 502 with its wireless communication circuit.

In the method 500 of FIG. 5, the mobile device 501 then transmits 508 the MAC address across another network to a remote server of the platform service provider 503. The platform service provider 503 then sends a host identifier, network purveyor, or other information to the mobile device 501. The mobile device 501 receives 510 this information from the platform service provider 503.

In one embodiment, the received information comprises host identifier information that is devoid of geographic coordinates. In one embodiment, the host identifier information comprises an identity of a purveyor of the available local area network.

Where there is a filter or other user configuration operating in the mobile device 501, the mobile device 501 may access 511 a predetermined list of allowable local area networks. If the available local area network is not within the predetermined list, the mobile device 501 may preclude the information from being received. Otherwise, the mobile device 501 determines 512 the host identifier of the available local area network.

Where the information is not precluded, the mobile device 501 can, upon determining the host identifier, transmit 513 a registration request to the base station 502. The base station 502 then receives 514 the network registration request from the mobile device 501. In response, the base station 502 can being pushing 515 content to the mobile device 501. As noted above, in one embodiment the received content corresponds to a host of the available local area network. Where that host is a business operation, the content can comprise promotional offers from the business operation. In one or more embodiments, the host identifier received from the platform service provider 503 is geographic coordinate free. However, the content comprises information identifying a location of the host of the local area network.

Turning now to FIG. 6, many of the steps of this method 600 are largely the same as in FIG. 5. A provider of a local area network subscribes 650 to a remote server of the platform service provider 603 by providing its MAC address and content to be stored 651 with the MAC address in a table of the platform service provider 603. The provider may also instruct the remote server of the platform service provider 603 to deliver the content to mobile devices upon receipt of the MAC address from those devices.

In this embodiment, the mobile device 601 caches 660 the table comprising MAC addresses and provider content from the platform service provider 603. This table is then stored in memory where it can be locally accessed by the mobile device 601.

The mobile device 601 scans 604 for available local area networks. The base station 602 pushes 606 its MAC address to the mobile device 601. In one embodiment, the base station 602 pushes 606 only its MAC address to the mobile device 601. The mobile device 601 then receives 607 the MAC address of the base station 602 with its wireless communication circuit.

In the method 600 of FIG. 6, the mobile device 601 then determines 661 the host identifier by referencing the lookup table in memory. In one embodiment, the lookup table comprises a plurality of media access control addresses each correlated to a unique host identifier. Where the MAC address is listed, the mobile device 601 can determine the host identifier corresponding to the MAC address.

Where there is a filter or other user configuration operating in the mobile device 601, the mobile device 601 may access 611 a predetermined list of allowable local area networks. If the available local area network is not within the predetermined list, the mobile device 601 may discard the accessed information.

Where the information is allowable, the mobile device 601 can, upon determining the host identifier, transmit 613 a registration request to the base station 602. The base station 602 then receives 614 the network registration request from the mobile device 601. In response, the base station 602 can being pushing 615 content to the mobile device 601.

Embodiments of the present invention provide network and location identification techniques that do not every require resolving latitude and geographic coordinates. Instead, embodiments of the invention employ MAC addresses as location objects. The MAC addresses are pushed to mobile devices. The mobile devices, in turn, determine host identifiers, network purveyors, or location information from the MAC addresses themselves. Accordingly, users of mobile devices can subscribe to a push-based system that notifies the user when they are near or within a particular local area network. The MAC addresses never have to be translated into latitudinal or longitudinal coordinates to provide this information.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in a mobile device,
scanning for available local area networks with a wireless communication circuit of the mobile device;
upon detecting an available local area network, receiving a media access control address of a base station in the available local area network with the wireless communication circuit; and
determining, with one or more processors of the mobile device, a host identifier of the available local area network from the media access control address.

2. The method of claim 1, wherein the host identifier is devoid of geographic coordinates.

3. The method of claim 1, wherein the host identifier comprises an identity of a purveyor of the available local area network.

4. The method of claim 1, further comprising, upon determining the host identifier, transmitting with the wireless communication circuit a registration request to the base station.

5. The method of claim 4, further comprising, in response to transmitting the registration request, receiving content corresponding to a host of the available local area network.

6. The method of claim 5, wherein the host comprises a business operation and the content comprises promotional offers from the business operation.

7. The method of claim 5, wherein the host identifier is geographic coordinate free, further where the content comprises information identifying a location of the host.

8. The method of claim 1, wherein the determining comprises:
transmitting the media access control address across another network to a remote server; and
receiving the host identifier from the remote server.

9. The method of claim 1, wherein the determining comprises referencing a table cached in a memory of the mobile device, wherein the table comprises a plurality of media access control addresses each correlated to a unique host identifier.

10. The method of claim 1, further comprising:
accessing a predetermined list of allowable local area networks; and
precluding the receiving when the available local area network is not in the predetermined list of allowable local area networks.

11. A method in a base station of a local area network, comprising:
detecting a mobile device being present in the local area network;
pushing a media access control address of the base station to the mobile device; and
in response to the pushing, delivering content corresponding to a host of the local area network to the mobile device.

12. The method of claim 11, further comprising receiving a network registration request from the mobile device.

13. The method of claim 11, wherein the pushing comprises pushing only the media access control address to the mobile device.

14. The method of claim 11, further comprising:
subscribing to a remote server by providing the media access control address and the content to the remote server; and
instructing the remote server to deliver the content to mobile devices upon receipt of the media access control address.

15. A mobile device, comprising:
a communication circuit configured to search for available local area networks; and
a control circuit, operable with the communication circuit, and configured to:
receive a media access control address from an available local area network detected by the communication circuit; and
determine a provider of the available local area network from the media access control address.

16. The mobile device of claim 15, further comprising a display, operable with the control circuit, wherein the control circuit is operable to present indicia of the provider on the display in response to the determining

17. The mobile device of claim 15, wherein the control circuit is configured to transmit the media access control address received from the available local area network to a remote server, further wherein the determining comprises receiving the provider from the remote server in response to sending the media access control address.

18. The mobile device of claim 15, wherein the control circuit is configured to register the mobile device with the available local area network after the provider is determined

19. The mobile device of claim 15, wherein the control circuit is configured to register the mobile device with the available local area network only where the provider is found in a predetermined list of providers stored in the mobile device.

20. The mobile device of claim 15, wherein the control circuit is further configured to determine its geographic location from the media access control address without using geographic coordinates.
